(19) United States
(12) Patent Application Publication
(10) Pub. No.: US 2012/0228303 A1
(43) Pub. Date: Sep. 13, 2012

(54) BAG AND CONTAINER FOR COLLECTING RECYCLABLE GARBAGE

(75) Inventor: Makoto YAMANE, Iwakuni-shi (JP)

(73) Assignee: YAMAGUCHI CAR - MATERIAL CO., LTD., Iwakuni-shi (JP)

(21) Appl. No.: 13/157,485

(22) Filed: Jun. 10, 2011

(30) Foreign Application Priority Data
Mar. 9, 2011 (JP) 2011-001277 U

(51) Int. Cl. B65F 1/06

(52) U.S. Cl. 220/495.06

(57) ABSTRACT

The present invention provides a bag and a container for collecting a recyclable garbage that is a plastic bag or container, wherein an opening having an opening base part is formed at an inlet of the bag or on one side of the container, a cover member that is positioned at the inner side of the opening has an area larger than that of the opening and has a biasing unit toward the opening is provided, and the cover member opens inwardly, but stops at the opening in the outward direction.

### BACKGROUND OF THE INVENTION

1. Field of the Invention

The present invention relates to a bag and a container for collecting a recyclable garbage, and more particularly to a bag and a container for collecting a recyclable garbage that collects garbage from home, a shop, or an office, particularly collects a packaging material made of plastic material that is a recyclable garbage.

2. Description of the Related Art

Conventionally, beverage PET bottles, beverage cans, and food trays are collected recyclably, but packaging materials such as plastic wrapping papers, plastic sheets used for a bag for snacks and plastic bags are not recycled but discarded with paper garbage, and most of them are subject to an incineration treatment, because the used amount of the packaging materials is very small.

Even when the packaging materials such as plastic sheet materials or bags are put into a container as a garbage as being compressed, they are restored due to their elasticity. Therefore, they are bulky. A packaging material to shrink-package a container may be scattered with a blow of wind, and every time they are put in a garbage bag, an inlet of the garbage bag has to be opened, and then closed after they are put therein, which is troublesome.

A garbage compressing apparatus for compressing bulky garbage such as plastic sheets so as to reduce the volume (referred to as volume reduction) has been present. For example, it is described in Japanese Patent Application Laid-Open No. 09-012103.

However, this invention is directed to a mechanical apparatus including a pressing device and an open/close preventing device, wherein a garbage bag is set. The apparatus also includes an electrical system for the operation. In this apparatus, an operation of taking out the compressed garbage is troublesome, and the apparatus is always installed, so that it occupies a place.

Although disposable bags are present as plastic bags, an upper frame and a lower frame, having a frame-like shape, are constituted of plural leg portions, wherein a pair of projections is formed on the frame-like upper frame. With this configuration, a garbage bag is set in a state in which an upper opening thereof is opened. A separate cover member is provided so as to cover the opening. The operation of removing the garbage bag is also troublesome. This is described in Japanese Patent Application Laid-Open No. 11-139506.

### SUMMARY OF THE INVENTION

In view of the above, the present invention develops and provides a bag and a container for collecting a recyclable garbage that can attain a volume reduction of garbage, is easy-to-handle, and facilitates recycling. The present invention provides a disposable plastic bag or container, which mainly accommodates a packaging material such as a wrapping paper for candy or plastic film or bag for snack in a unilateral way, until the bag or container is filled with the plastic material.

In order to solve the problem, the present invention provides a bag or a container for collecting a recyclable garbage that is a plastic bag or container, wherein an opening is formed on one surface of the bag or the container, a cover member that closes the opening so as to be able to open is provided at the inner side of the opening, and garbage can be put therein from the outside, but the garbage inside cannot be removed to the outside.

According to the present invention, beverage PET bottles, beverage cans, food trays, other plastic packaging materials that have been used and recycled and a small amount of garbage or metallic parts serving as the other resources, are accommodated, and recycled. Accordingly, the present invention provides extremely advantageous effects such as resource circulation, CO₂ emission restrictions, environment beautification, and enhancement in consciousness in resources and environment by children and community.

### BRIEF DESCRIPTION OF THE DRAWINGS

FIG. 1 is a perspective view illustrating one embodiment of the present invention;

FIG. 2 is a perspective view illustrating another embodiment of the present invention;

FIG. 3 is a partially cutout enlarged sectional view illustrating one embodiment of the present invention; and

FIGS. 4a to 4c illustrate one embodiment of the present invention, and are partially cutout enlarged sectional views each illustrating a sealing unit.

### DETAILED DESCRIPTION OF THE INVENTION

The present invention provides a bag and a container for collecting a recyclable garbage that is a plastic bag or container, wherein an opening having an opening base part is formed at an inlet of the bag or on one side of the container, a cover member that is positioned at the inner side of the opening has an area larger than that of the opening and has a encouraging unit toward the opening is provided, and the cover member opens inwardly, but stops at the opening in the outward direction.

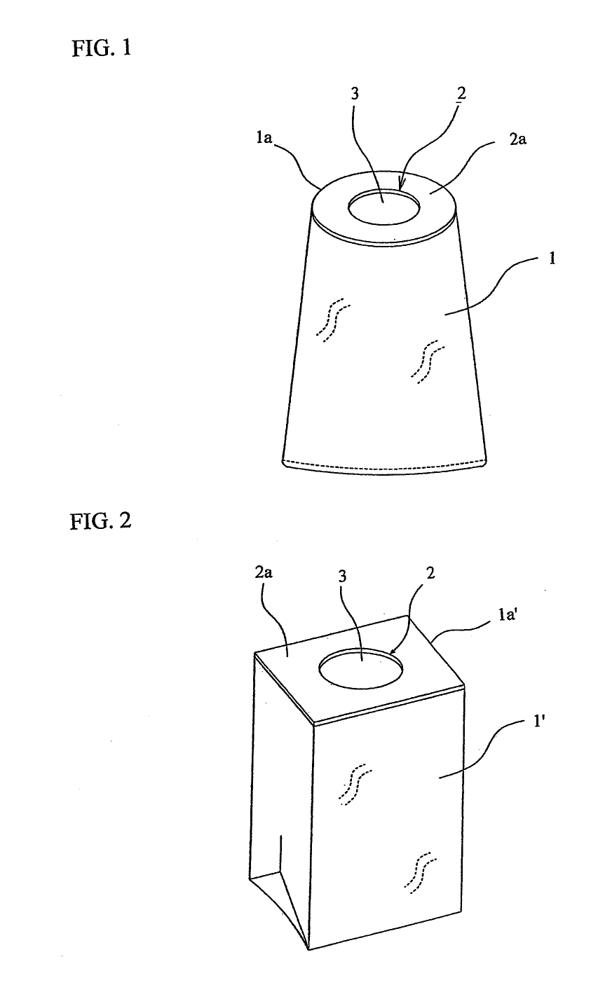

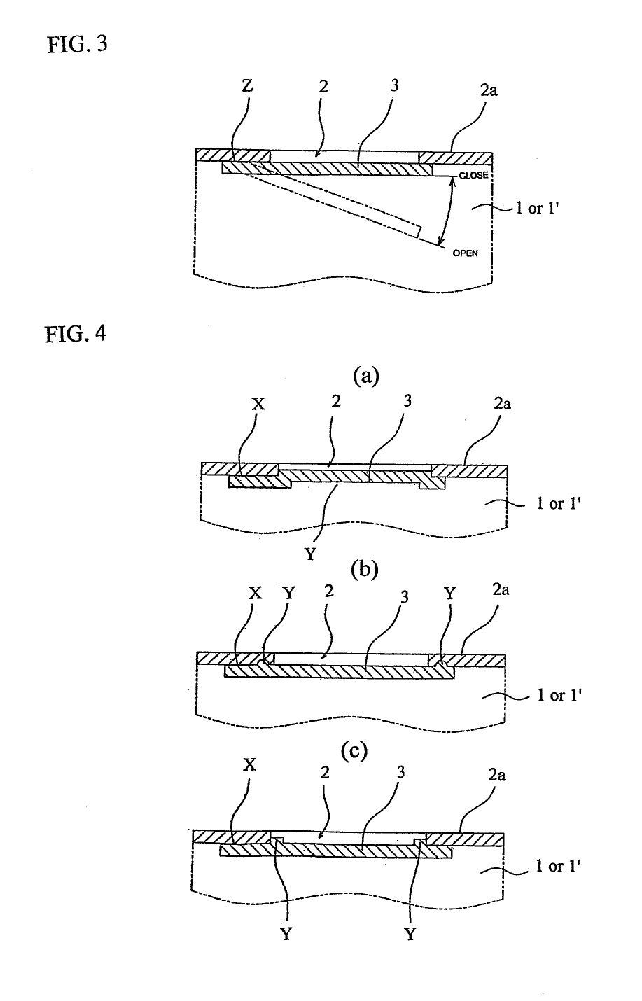

One embodiment of the present invention will be described in detail with reference to FIGS. 1 and 2. A bag and a container for collecting a recyclable garbage is a plastic bag (1) or container (1′), wherein an opening (2) having an opening base part (2a) is formed at an inlet (1a) of the bag (1) or at one side (1′a) of the container (1′), a cover member (3) that is positioned at the inner side of the opening (2) has an area larger than that of the opening (2) and has a encouraging unit (X) toward the opening (2) is provided, and the cover member (3) opens inwardly, but stops at the opening (2) in the outward direction.

In the bag and the container for collecting the recyclable garbage, the plastic bag (1) or container (1′) is made of a transparent or semi-transparent material, whereby, even when a time bomb is set in the bag, it can easily be recognized visually from the outside, which prevents terrorist attacks. Further, in a district where a separate collection of garbage is performed, a sanitary worker can easily see the inside, whereby a working efficiency is enhanced.

As illustrated in FIGS. 4a to 4c, the opening (2) and the cover member (3) form a sealing unit (Y) having a concave and convex part. Therefore, even when food residue is slightly deposited on the garbage, the bag and the container for collecting a recyclable garbage are kept sanitary, because they prevent the garbage from being covered by flies.

In addition, when a garbage discharged from a medical institution such as a used syringe needle is to be put in the container (1′), the garbage is placed on the opening (2), which is pushed open using a pin or the like, whereby the garbage drops into inside the container (1′). In this manner, it is possible to safely collect the garbage without touching it by hand.

The plastic bag (1) or container (1′) is formed to be foldable, or into an extensible form such as bellows, whereby it is compact when not used, and even when a large amount of them is stored, they do not occupy the place. Therefore, it is convenient for storage.

When a technique of manufacturing the bag and the container for collecting a recyclable garbage is learned, and the bag and the container are put into practical use and sold, the present invention provides industrial applicability.

What is claimed is:

1. A bag and a container for collecting a recyclable garbage that is a plastic bag or container, wherein an opening having an opening base part is formed at an inlet of the bag or on one side of the container, a cover member that is positioned at the inner side of the opening has an area larger than that of the opening and has a encouraging unit toward the opening is provided, and the cover member opens inwardly, but stops at the opening in the outward direction.

2. The bag and the container for collecting a recyclable garbage according to claim 1, wherein the plastic bag or container is made of a transparent or semi-transparent material.

3. The bag and the container for collecting a recyclable garbage according to claim 2, wherein the opening and the cover member form a sealing unit having a concave and convex shape.

4. The bag and the container for collecting a recyclable garbage according to claim 1 or 2, wherein the plastic bag or container is foldable or extensible.
